(19) United States
(12) Patent Application Publication
(10) Pub. No.: US 2020/0334261 A1
(43) Pub. Date: Oct. 22, 2020

(54) SEARCH RANKING METHOD AND APPARATUS, ELECTRONIC DEVICE AND STORAGE MEDIUM

(71) Applicant: Tianjin Bytedance Technology Co., Ltd., Tianjin (CN)

(72) Inventor: Zhao PENG, Beijing (CN)

(21) Appl. No.: 16/760,698

(22) PCT Filed: Nov. 1, 2018
(86) PCT No.: PCT/CN2018/113427

§ 371 Date: Apr. 30, 2020

(30) Foreign Application Priority Data
Jul. 27, 2018 (CN) 201810848393.X

(51) Int. Cl. G06F 16/2457; G06K 9/62; G06F 16/9535; H04L 12/58

(52) U.S. Cl. CPC G06F 16/24578; H04L 51/16; G06F 16/9535; G06K 9/6215

(57) ABSTRACT

The present application relates to a multi-dimensional search ranking method and apparatus, an electronic device and a storage medium. In an embodiment of the method, acquiring search keywords and determining a plurality of initial search results that match with the keywords; extracting a text similarity, an update time dimension and a click rate associated with each of the initial search results; acquiring a weight of the text similarity, a weight of the update time dimension and a weight of the click rate, and performing a fusion calculation to obtain a comprehensive weight of each of the initial search results; and ranking the plurality of initial search results according to the comprehensive weights. This method facilitates users in quickly finding relevant information, simplifies the operation, and improves the searching efficiency.

### CROSS-REFERENCE TO RELATED APPLICATIONS

The present application claims priority to Chinese patent application No. 201810848393.X, titled “Search Ranking Method and Apparatus, Computer Device and Storage Medium”, filed by the applicant “Tianjin Bytedance Technology Co., Ltd” on Jul. 27, 2018 with the Chinese Patent Office, which is incorporated herein by reference in this entity.

### FIELD OF THE INVENTION

The present application relates to the technical field of enterprise instant messaging systems, and in particular to a search ranking method, a search ranking apparatus, an electronic device and a storage medium.

### BACKGROUND OF THE INVENTION

With the rapid development of smart devices, more and more chat applications have emerged, and the use of chat applications enables users far away from each other to communicate. The chat applications include personal chat applications and enterprise chat applications. During the use of the enterprise chat applications, when the user needs to search for relevant information, a search function is activated, such as searching for chat information, contacts or group chats, so that the relevant information can be quickly found or a chat link can be quickly established.

At present, the following problem exists when the search function of the enterprise chat application is implemented:

initial search results of the enterprise chat application are displayed separately according to different objects, wherein information such as contacts, group chats, messages and the like are displayed in separate columns; moreover, the displayed objects are ranked in a chronological order, and the user searches for relevant information according to the displayed columns, making the operation cumbersome and time consuming.

### SUMMARY OF THE INVENTION

On this basis, it is necessary to provide a search ranking method, a search ranking apparatus, an electronic device and a storage medium that are capable of multi-dimensional search ranking in view of the above technical problems.

One aspect of the present application provides a search ranking method, which includes:

acquiring search keywords and determining a plurality of initial search results that match with the keywords;

extracting a text similarity, an update time dimension and a click rate associated with each of the initial search results;

acquiring a weight of the text similarity, a weight of the update time dimension and a weight of the click rate according to the text similarity, the update time dimension and the click rate, and performing a fusion calculation according to the weight of the text similarity, the weight of the update time dimension and the weight of the click rate to obtain a comprehensive weight of each of the initial search results; and

ranking the plurality of initial search results according to the comprehensive weights.

In one of the embodiments, the acquiring the weight of the text similarity includes:

calculating a hit ratio, a sequence consistency indicator, a position tightness, and a coverage ratio of the keywords in the initial search results; and

calculating the weight of the text similarity according to the hit ratio, the sequence consistency indicator, the position tightness, and the coverage ratio.

In one of the embodiments, the step of calculating the weight of the text similarity according to the hit ratio, the sequence consistency indicator, the position tightness and the coverage ratio includes:

acquiring an offset value and a correction value respectively, according to the hit ratio, the sequence consistency indicator, the position tightness, and the coverage ratio;

and

performing a fusion calculation according to the hit ratio, the sequence consistency indicator, the position tightness, the coverage ratio, the offset value and the correction value to obtain the weight of the text similarity.

In one of the embodiments, the acquiring the weight of the update time dimension includes:

acquiring a time interval between the last chat time and the current time according to the initial search results; and

calculating a ratio of an attenuation constant to the sum of the time interval and the attenuation constant to obtain the weight of the chat update time.

In one of the embodiments, the acquiring the weight of the click rate includes:

acquiring the number of user clicks of the initial search results; and

assigning a value to the weight of the click rate according to the number of user clicks; wherein the weight of the click rate is in direct proportional to the number of user clicks.

In one of the embodiments, the performing the fusion calculation according to the weight of the text similarity, the weight of the update time dimension and the weight of the click rate to obtain the comprehensive weight of each of the initial search results includes:

normalizing the weight of the text similarity, the weight of the update time dimension, and the weight of the click rate to a decimal between 0 and 1; and

performing the fusion calculation according to the normalized weight of the text similarity, the normalized weight of the update time dimension and the normalized weight of the click rate to obtain the comprehensive weight of each of the initial search results.

In one of the embodiments, the acquiring the weight of the text similarity, the weight of the update time dimension and the weight of the click rate according to the text similarity, the update time dimension and the click rate, and performing the fusion calculation according to the weight of the text similarity, the weight of the update time dimension and the weight of the click rate to obtain the comprehensive weight of each of the initial search results includes:

calculating the weight of the text similarity, the weight of the update time dimension and the weight of the click rate according to the text similarity, the update time dimension and the click rate;

acquiring an offset value and a correction value respectively, according to the weight of the text similarity, the weight of the update time dimension and the weight of the click rate;

obtaining a fusion coefficient by calculating a sum of a product of the weight of the text similarity and the corresponding offset value, and the corresponding correction value; obtaining a fusion coefficient by calculating a sum of a product of the weight of the update time dimension and the corresponding offset value, and the corresponding correction value; and obtaining a fusion coefficient by calculating a sum of a product of the weight of the click rate and the corresponding offset value, and the corresponding correction value;

and

multiplying the fusion coefficients to obtain a comprehensive weight of each of the initial search results.

In one of the embodiments, before extracting the text similarity, the update time dimension, and the click rate associated with each of the initial search results, the method further includes:

screening the initial search results;

wherein the screening the initial search results includes:

not ranking the initial search results of the users who have resigned and have no chat records; and

ranking the initial search results of unregistered users at the end.

Another aspect of the present application provides a search ranking apparatus, which includes:

an initial search result extraction module, configured to acquire search keywords and determine a plurality of initial search results that match with the keywords;

a characteristic factor extraction module, configured to extract a text similarity, an update time dimension and a click rate associated with each of the initial search results;

a comprehensive weight calculation module, configured to acquire a weight of the text similarity, a weight of the update time dimension and a weight of the click rate according to the text similarity, the update time dimension and the click rate, and perform a fusion calculation according to the weight of the text similarity, the weight of the update time dimension and the weight of the click rate to obtain a comprehensive weight of each of the initial search results; and

a ranking module, configured to rank the plurality of initial search results according to the comprehensive weights.

In one of the embodiments, the comprehensive weight calculation module includes:

a unit for calculating the weight of text similarity, configured to calculate a hit ratio, a sequence consistency indicator, a position tightness, and a coverage ratio of the keywords in the initial search results, and calculate the weight of the text similarity according to the hit ratio, the sequence consistency indicator, the position tightness, and the coverage ratio.

In one of the embodiments, the unit for calculating the weight of text similarity includes:

a sub-unit for acquiring offset value and correction value, configured to acquire an offset value and a correction value respectively, according to the hit ratio, the sequence consistency indicator, the position tightness, and the coverage ratio; and

a sub-unit for fusion-calculating the weight of text similarity, configured to perform a fusion calculation according to the hit ratio, the sequence consistency indicator, the position tightness, the coverage ratio, the offset value and the correction value to obtain the weight of the text similarity.

In one of the embodiments, the comprehensive weight calculation module includes:

a unit for calculating the weight of update time dimension, configured to acquire a time interval between the last chat time and the current time according to the initial search results, and calculate a ratio of an attenuation constant to the sum of the time interval and the attenuation constant to obtain the weight of the chat update time.

In one of the embodiments, the comprehensive weight calculation module includes:

a unit for calculating the weight of click rate, configured to acquire the number of user clicks of the initial search results, and assign a value to the weight of the click rate according to the number of user clicks; wherein the weight of the click rate is in direct proportional to the number of user clicks.

In one of the embodiments, the comprehensive weight calculation module includes:

a normalization unit, configured to normalize the weight of the text similarity, the weight of the update time dimension, and the weight of the click rate to a decimal between 0 and 1; and

a fusion calculation unit, configured to perform fusion calculation according to the normalized weight of the text similarity, the normalized weight of the update time dimension and the normalized weight of the click rate to obtain the comprehensive weight of each of the initial search results.

In one of the embodiments, the comprehensive weight calculation module includes:

a weight acquisition unit, configured to calculate the weight of the text similarity, the weight of the update time dimension and the weight of the click rate according to the text similarity, the update time dimension and the click rate;

an offset value and correction value acquisition unit, configured to acquire an offset value and a correction value respectively, according to the weight of the text similarity, the weight of the update time dimension and the weight of the click rate;

a fusion coefficient calculation unit, configured to obtain a fusion coefficient by calculating a sum of a product of the weight of the text similarity and the corresponding offset value, and the corresponding correction value, to obtain a fusion coefficient by calculating a sum of a product of the weight of the update time dimension and the corresponding offset value, and the corresponding correction value, and to obtain a fusion coefficient by calculating a sum of a product of the weight of the click rate and the corresponding offset value, and the corresponding correction value; and

a comprehensive weight calculation unit, configured to multiply the fusion coefficients to obtain a comprehensive weight of each of the initial search results.

In one of the embodiments, the apparatus further includes:

a screening module, configured to screen the initial search results;

wherein the screening module is specifically configured to:

not rank the initial search results of the users who have resigned and have no chat records; and

rank the initial search results of unregistered users at the end.

Further another aspect of the present application provides an electronic device including a memory having a computer program stored thereon, and a processor, wherein when the computer program is executed by the processor, the following steps are implemented:

acquiring search keywords and determining a plurality of initial search results that match with the keywords;

extracting a text similarity, an update time dimension and a click rate associated with each of the initial search results;

acquiring a weight of the text similarity, a weight of the update time dimension and a weight of the click rate according to the text similarity, the update time dimension and the click rate, and performing a fusion calculation according to the weight of the text similarity, the weight of the update time dimension and the weight of the click rate to obtain a comprehensive weight of each of the initial search results; and

ranking the plurality of initial search results according to the comprehensive weights.

Still another aspect of the present application provides a computer readable storage medium having a computer program stored thereon, wherein when the computer program is executed by a processor, the following steps are implemented:

acquiring search keywords and determining a plurality of initial search results that match with the keywords;

extracting a text similarity, an update time dimension and a click rate associated with each of the initial search results;

acquiring a weight of the text similarity, a weight of the update time dimension and a weight of the click rate according to the text similarity, the update time dimension and the click rate, and performing a fusion calculation according to the weight of the text similarity, the weight of the update time dimension and the weight of the click rate to obtain a comprehensive weight of each of the initial search results; and

ranking the plurality of initial search results according to the comprehensive weights.

With the above search ranking method, search ranking apparatus, electronic device and storage medium, it is ensured that the ranking is performed based on time by extracting the weight of update time dimension, and it is ensured that initial search results that have never been contacted but are important are ranked ahead by extracting the weight of click rate. The initial search results are ranked by multiple dimensions, so that the ranking is made intelligent, which facilitates users in quickly finding relevant information, simplifies the operation, and improves the searching efficiency.

### BRIEF DESCRIPTION OF THE DRAWINGS

In order to illustrate the technical solutions in the embodiments of the present disclosure more clearly, one or more embodiments will be illustratively described below with reference to the figures in the corresponding accompanying drawings, and the illustrative description should not be construed as limiting the embodiments, wherein:

FIG. 1 is an application environment diagram of a search ranking method according to an embodiment;

FIG. 2 is a schematic flow chart of a search ranking method according to an embodiment;

FIG. 3 is a schematic flow chart showing the steps of acquiring the weight of text similarity in an embodiment;

FIG. 4 is a schematic flow chart showing the steps of acquiring the weight of update time dimension in an embodiment;

FIG. 5 is a schematic flow chart showing the steps of acquiring the weight of click rate in an embodiment;

FIG. 6 is a structural block diagram of a search ranking apparatus according to an embodiment;

FIG. 7 is a structural block diagram of a characteristic factor extraction module in an embodiment;

FIG. 8 is a structural block diagram of a comprehensive weight calculation module in an embodiment; and

FIG. 9 is an internal structure diagram of an electronic device according to an embodiment.

### DETAILED DESCRIPTION OF THE EMBODIMENT(S) OF THE INVENTION

In order to make the objects, technical solutions and advantages of the present application more clearly understood, the present application will be further described below in detail with reference to the accompanying drawings and embodiments. It should be understood that the specific embodiments described herein merely serve to explain the present application, and are not intended to limit the present application.

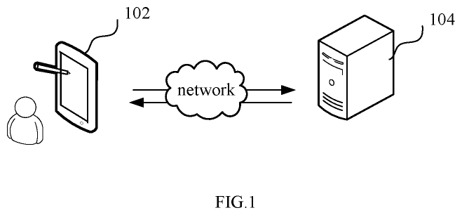

The multi-dimensional search ranking method provided by the present application may be applied to an application environment as shown in FIG. 1. A terminal 102 communicates with a server 104 via a network. Search keywords are entered at the terminal 102, and the server 104 acquires the search keywords and determines a plurality of initial search results that match with the keywords; a text similarity, an update time dimension and a click rate associated with each of the initial search results are extracted, according to the initial search results; a weight of the text similarity, a weight of the update time dimension and a weight of the click rate are acquired according to the text similarity, the update time dimension and the click rate, and a fusion calculation is performed according to the weight of the text similarity, the weight of the update time dimension and the weight of the click rate to obtain a comprehensive weight of each of the initial search results; and the plurality of initial search results are ranked according to the comprehensive weights, and a result of the ranking is displayed in the terminal 102. The terminal 102 may be, but is not limited to, various personal computers, notebook computers, smart phones, tablets, and portable wearable devices. The server 104 may be implemented by an independent server, or a server cluster composed of a plurality of servers.

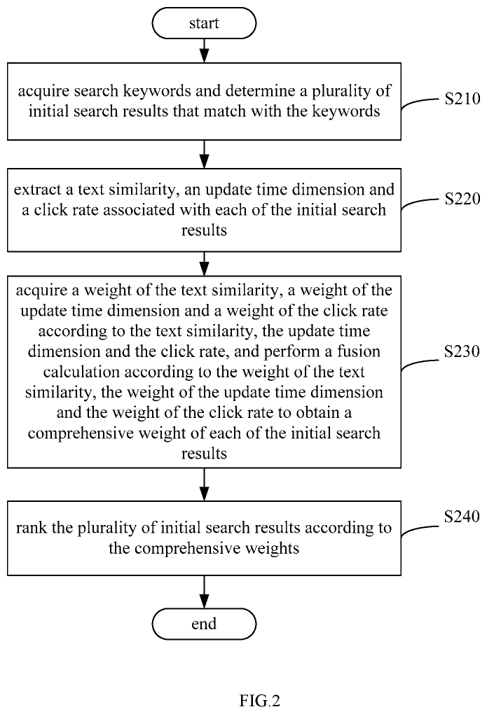

In an embodiment, as shown in FIG. 2, a search ranking method is provided, and a description will be given below by using an example in which the method is applied to the server in FIG. 1, wherein the method includes the following steps S210-S240.

S210: acquiring search keywords and determining a plurality of initial search results that match with the keywords.

The search keywords are input information entered by the user when searching for relevant information using a search engine, such as words, terms, symbols and the like. In this embodiment, the initial search results include a plurality of columns, such as a contact column, a group chat column, and a message column.

Specifically, the search keywords are entered at the terminal, and the terminal acquires the search keywords entered by the user and sends them to a server via the network.

S220: extracting a text similarity, an update time dimension and a click rate associated with each of the initial search results.

Fields included in each initial search result include: object type, object status, object name, score of initially recalling search engine, chat update time, position of the latest message, Chinese pinyin name of the object, English name of the object, and the department in which the object is located, wherein the object type includes a chat application and a mail, and the object status includes whether the object is registered, and whether the object has resigned.

In an optional embodiment, before extracting the text similarity, the update time dimension, and the click rate associated with each of the initial search results, the method further includes: screening the initial search results. The screening the initial search results includes: not ranking the initial search results of the users who have resigned and have no chat records, and ranking the initial search results of unregistered users at the end. A chat history may be determined by the chat update time or the position corresponding to the latest message.

S230: acquiring a weight of the text similarity, a weight of the update time dimension and a weight of the click rate according to the text similarity, the update time dimension and the click rate, and performing a fusion calculation according to the weight of the text similarity, the weight of the update time dimension and the weight of the click rate to obtain a comprehensive weight of each of the initial search results.

The weight of text similarity is configured to characterize a matching degree between the search keywords and the initial search results, the weight of update time dimension is configured to characterize an update status of chat records of the initial search results, and the weight of click rate is configured to characterize that the initial search results are the targets that a plurality of user are interested in.

S240: ranking the plurality of initial search results according to the comprehensive weights.

The ranking may be performed according to the comprehensive weights in an order from large to small, or may be performed according to the comprehensive weights in an order from small to large. Such a technical solution does not distinguish the ranking manners according to the columns, but performs the ranking according to the weights, so as to quickly find relevant information.

In the above search ranking method, it is ensured that the ranking is performed based on time by extracting the weight of update time dimension, and it is ensured that initial search results that have never been contacted but are important are ranked ahead by extracting the weight of click rate. The initial search results are ranked by multiple dimensions, so that the ranking is made intelligent, which facilitates users in quickly finding relevant information, simplifies the operation, and improves the searching efficiency.

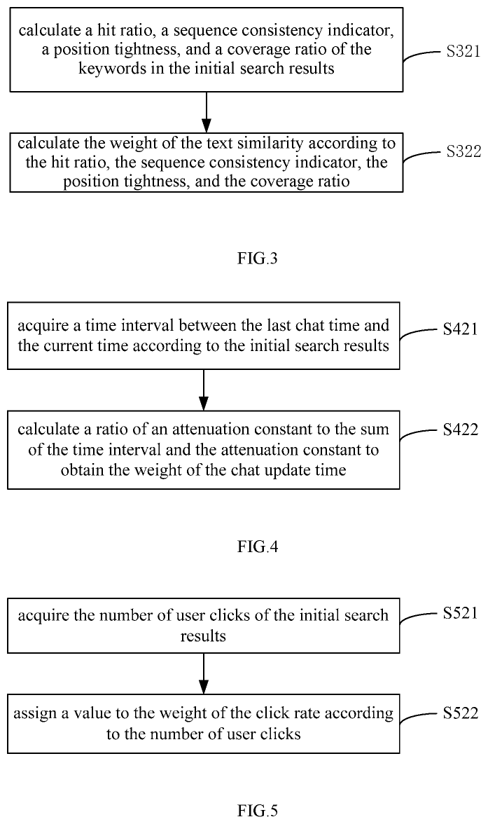

In one of the embodiments, as shown in FIG. 3, the acquiring the weight of the text similarity includes:

S321: calculating a hit ratio, a sequence consistency indicator, a position tightness, and a coverage ratio of the keywords in the initial search results; and

S322: calculating the weight of the text similarity according to the hit ratio, the sequence consistency indicator, the position tightness, and the coverage ratio.

In one of the embodiments, the step of calculating the weight of the text similarity according to the hit ratio, the sequence consistency indicator, the position tightness and the coverage ratio includes: acquiring an offset value and a correction value respectively, according to the hit ratio, the sequence consistency indicator, the position tightness, and the coverage ratio; and performing a fusion calculation according to the hit ratio, the sequence consistency indicator, the position tightness, the coverage ratio, the offset value and the correction value to obtain the weight of the text similarity. The offset value and the correction value may be determined by machine learning. The acquiring the offset value and the correction value respectively according to the hit ratio, the sequence consistency indicator, the position tightness and the coverage ratio includes: acquiring the offset value and the correction value according to the hit ratio, acquiring the offset value and the correction value according to the sequence consistency indicator, acquiring the offset value and the correction value according to the position tightness, and acquiring the offset value and the correction value according to the coverage ratio.

In one of the embodiments, the formula of calculating the weight of the text similarity specifically is:

text similar=(a*hit+b)*(c*sequence+d)*(e*position+f)*(g*cover+h);

wherein text similar is the weight of the text similarity, hit is the hit ratio of the text, sequence is the sequence consistency indicator, position is the position tightness, and cover is the coverage ratio; a and b are the offset value and the correction value of the hit ratio, c and d are the offset value and the correction value of the sequence consistency indicator, e and f are the offset value and the correction value of the position tightness, and g and h are the offset value and the correction value of the coverage ratio; wherein a larger offset value indicates a higher importance of the item involved. The hit ratio of the text indicates a ratio of the number of hits of the search keywords in the corresponding text document to the total number of search keywords. Obviously, the higher the ratio is, the closer the initial search result is to the search target. The sequence consistency indicator indicates the consistency of the sequence of the search keywords with the sequence of the search keywords appearing in the corresponding text document, and the sequence consistency is expressed by the ratio of the number of reversed sequences. For example, the number of reversed sequences of (1, 2, 3) is 0, which indicates a most sequenced arrangement, and the number of reversed sequences of (3, 2, 1) is 3, which indicates a least sequenced arrangement. The position tightness indicates a ratio of the number of hit text documents to the sum of the number of hit text documents and the number of hit spacers. For example, for the keywords “Zhang San, Zhang Si, Li Si”, the hit initial search results are “Zhang San” and “Li Si's group”, the hit keywords are “Zhang San, Li Si”, the number t of hit text documents is 2, and the number of the hit spacers is 1 (since there is a “Zhang Si” between the hit keywords). Therefore, the position tightness=2/(1+2)=⅔. The coverage ratio indicates a ratio of hit keywords to the total fields of all hit text documents.

In one of the embodiments, as shown in FIG. 4, the acquiring the weight of the update time dimension includes:

S421: acquiring a time interval between the last chat time and the current time according to the initial search results; and

S422: calculating a ratio of an attenuation constant to the sum of the time interval and the attenuation constant to obtain the weight of the chat update time.

In one of the embodiments, the formula of calculating the weight of the update time dimension is:

update_time_weight=factor/(factor+update_time_secs);

wherein update_time_weight is the weight of the update time dimension, factor is a constant which is attenuated over time, and the unit of the factor is second. Herein, the calculation is performed on a basis of attenuating by a half in 30 days, i.e., factor=30*24*3600=2592000. update_time_secs is the number of seconds till now since the last chat time. For example, if the last chat time is 30 days ago, then update_time_secs=30*24*3600=259200, and the update time dimension update_time_weight=259200/(259200+259200)=½.

In one of the embodiments, as shown in FIG. 5, the acquiring the weight of the click rate includes:

S521: acquiring the number of user clicks of the initial search results; and

S522: assigning a value to the weight of the click rate according to the number of user clicks; wherein the weight of the click rate is in direct proportional to the number of user clicks.

The currently searching user's clicks of the initial search results also often reflect the quality of the initial search results. For the initial search results clicked at a high frequency, the weights thereof are increased, and they are displayed preferentially at the time of ranking. Other users' clicks of the initial search results may also reflect the quality of the initial search results, which is specifically expressed as the ClickHeat of the initial search results. The ClickHeat of the initial search results may be calculated in real time. For example, in a certain period of time, if a certain popular person (initial search result) is clicked for many times, it can be ranked ahead immediately. Currently, the number of clicks of the initial search results is recorded in a database, and each initial search result may be ranked by scanning the number of clicks of the initial search results in real time. A higher ranking indicates a larger weight of the click rate, that is, the weight of the click rate is in direct proportion to the number of user clicks.

In one of the embodiments, the performing the fusion calculation according to the weight of the text similarity, the weight of the update time dimension and the weight of the click rate to obtain the comprehensive weight of each of the initial search results includes: normalizing the weight of the text similarity, the weight of the update time dimension, and the weight of the click rate to a decimal between 0 and 1; and performing the fusion calculation according to the normalized weight of the text similarity, the normalized weight of the update time dimension and the normalized weight of the click rate to obtain the comprehensive weight of each of the initial search results.

In one of the embodiments, the acquiring the weight of the text similarity, the weight of the update time dimension and the weight of the click rate according to the text similarity, the update time dimension and the click rate, and performing the fusion calculation according to the weight of the text similarity, the weight of the update time dimension and the weight of the click rate to obtain the comprehensive weight of each of the initial search results includes: calculating the weight of the text similarity, the weight of the update time dimension and the weight of the click rate according to the text similarity, the update time dimension and the click rate; acquiring an offset value and a correction value respectively, according to the weight of the text similarity, the weight of the update time dimension and the weight of the click rate; obtaining a fusion coefficient by calculating a sum of a product of the weight of the text similarity and the corresponding offset value, and the corresponding correction value; obtaining a fusion coefficient by calculating a sum of a product of the weight of the update time dimension and the corresponding offset value, and the corresponding correction value; and obtaining a fusion coefficient by calculating a sum of a product of the weight of the click rate and the corresponding offset value, and the corresponding correction value; and multiplying the fusion coefficients to obtain a comprehensive weight of each of the initial search results. The offset value and the correction value may be determined by machine learning.

In a specific embodiment, the formula of calculating the comprehensive weight is as follows:

weight=(a1*text weight+b1)*(a2*update_time_weight+b2)*(a3*click rate+b3);

wherein weight is the weight of the initial search result, text weight is the weight of the text similarity, update_time_weight is the weight of the update time dimension, and click rate is the weight of the click rate. In the formula, each parentheses includes therein a calculation of the fusion coefficient, wherein text weight represents the weight of the text similarity, a1 is the offset value, b1 is the correction value, and a first fusion coefficient is calculated by a1*text_weight+b1; update_time_weight represents the weight of the update time dimension, a2 is the offset value, b2 is the correction value, and a second fusion coefficient is calculated by a2*update_time_weight+b2; and a plurality of fusion coefficients are multiplied to obtain the comprehensive weight of the initial search result. In the formula, each of a1, a2 and a3 is an offset value, and each of b1, b2 and b3 is a correction value.

In an enterprise communication tool, by ranking the initial search results according the magnitudes of the weights thereof as in the embodiment of the present application, the ranking is no longer merely limited to a single time-based ranking. For various types of search objects such as contacts or group chats, a mixed ranking can be performed so that the most desired initial search results are presented to the users, thereby improving the efficiency of enterprise communication.

It should be understood that although the various steps in the flow charts of FIGS. 1-5 are sequentially displayed as indicated by the arrows, these steps do not necessarily have to be sequentially executed in the order indicated by the arrows. Unless explicitly stated herein, the execution of these steps is not strictly limited by any order, and they may be executed in other orders. Moreover, at least some of the steps in FIGS. 1-5 may include a plurality of sub-steps or stages, which are not necessarily executed or completed at the same time instants, but may be executed at different time instants. These sub-steps or stages are not necessarily executed sequentially, but may be executed alternately with at least a portion of other steps or at least a portion of sub-steps or stages of other steps.

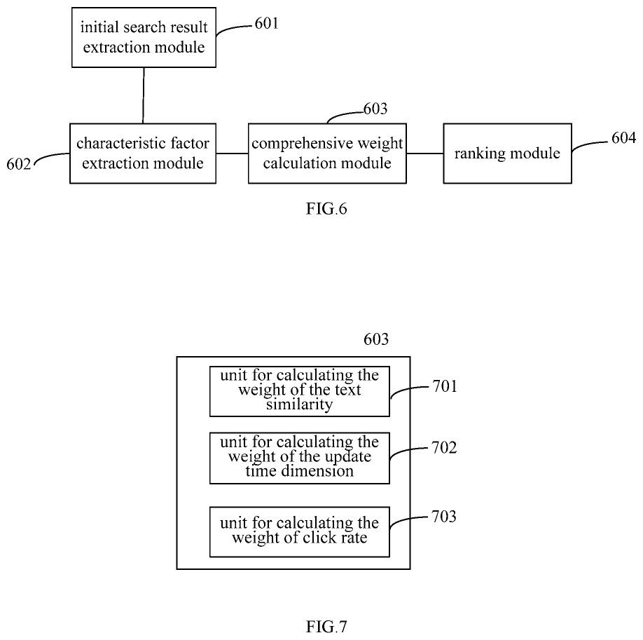

In one of the embodiments, as shown in FIG. 6, a search ranking apparatus is provided, which includes: an initial search result extraction module 601, a characteristic factor extraction module 602, a comprehensive weight calculation module 603 and a ranking module 604.

The initial search result extraction module 601 is configured to acquire search keywords and determine a plurality of initial search results that match with the keywords.

The search keywords are input information entered by the user when searching for relevant information using a search engine, such as words, terms, symbols and the like. In this embodiment, the initial search results include a plurality of columns, such as a contact column, a group chat column, and a message column.

Specifically, the search keywords are entered at the terminal, and the terminal acquires the search keywords entered by the user and sends them to a server via the network.

The characteristic factor extraction module 602 is configured to extract a text similarity, an update time dimension and a click rate associated with each of the initial search results.

Fields included in each initial search result include: object type, object status, object name, score of initially recalling search engine, chat update time, position of the latest message, Chinese pinyin name of the object, English name of the object, and the department in which the object is located, wherein the object type includes a chat application and a mail, and the object status includes whether the object is registered, and whether the object has resigned.

In an optional embodiment, the search ranking apparatus further includes: a screening module, configured to screen the initial search results. The screening the initial search results includes: not ranking the initial search results of the users who have resigned and have no chat records; and ranking the initial search results of unregistered users at the end. A chat history may be determined by the chat update time or the position corresponding to the latest message.

The comprehensive weight calculation module 603 is configured to acquire a weight of the text similarity, a weight of the update time dimension and a weight of the click rate according to the text similarity, the update time dimension and the click rate, and perform a fusion calculation according to the weight of the text similarity, the weight of the update time dimension and the weight of the click rate to obtain a comprehensive weight of each of the initial search results.

The weight of text similarity is configured to characterize a matching degree between the search keywords and the initial search results, the weight of update time dimension is configured to characterize an update status of chat records of the initial search results, and the weight of click rate is configured to characterize that the initial search results are the targets that a plurality of user are interested in.

The ranking module 604 is configured to rank the plurality of initial search results according to the comprehensive weights.

The ranking may be performed according to the comprehensive weights in an order from large to small, or may be performed according to the comprehensive weights in an order from small to large. Such a technical solution does not distinguish the ranking manners according to the columns, but performs the ranking according to the weights, so as to quickly find relevant information.

In the above search ranking apparatus, it is ensured that the ranking is performed based on time by extracting the weight of update time dimension, and it is ensured that initial search results that have never been contacted but are important are ranked ahead by extracting the weight of click rate. The initial search results are ranked by multiple dimensions, so that the ranking is made intelligent, which facilitates users in quickly finding relevant information, simplifies the operation, and improves the searching efficiency.

In one of the embodiments, as shown in FIG. 7, the comprehensive weight calculation module 603 includes: a unit 701 for calculating the weight of text similarity, a unit 702 for calculating the weight of update time dimension, and a unit 703 for calculating the weight of click rate.

The unit 701 for calculating the weight of text similarity is configured to calculate a hit ratio, a sequence consistency indicator, a position tightness, and a coverage ratio of the keywords in the initial search results, and calculate the weight of the text similarity according to the hit ratio, the sequence consistency indicator, the position tightness, and the coverage ratio.

In one of the embodiments, the unit for calculating the weight of text similarity includes: a sub-unit for acquiring offset value and correction value, configured to acquire an offset value and a correction value respectively, according to the hit ratio, the sequence consistency indicator, the position tightness, and the coverage ratio; and a sub-unit for fusion-calculating the weight of text similarity, configured to perform a fusion calculation according to the hit ratio, the sequence consistency indicator, the position tightness, the coverage ratio, the offset value and the correction value to obtain the weight of the text similarity. The offset value and the correction value may be determined by machine learning. The acquiring the offset value and the correction value respectively according to the hit ratio, the sequence consistency indicator, the position tightness and the coverage ratio includes: acquiring the offset value and the correction value according to the hit ratio, acquiring the offset value and the correction value according to the sequence consistency indicator, acquiring the offset value and the correction value according to the position tightness, and acquiring the offset value and the correction value according to the coverage ratio.

In one of the embodiments, the formula of calculating the weight of the text similarity specifically is:

text_similar=(a*hit+b)*(c*sequence+d)*(e*position+f)*(g*cover+h);

wherein text_similar is the weight of the text similarity, hit is the hit ratio of the text, sequence is the sequence consistency indicator, position is the position tightness, and cover is the coverage ratio; a and b are the offset value and the correction value of the hit ratio, c and d are the offset value and the correction value of the sequence consistency indicator, e and f are the offset value and the correction value of the position tightness, and g and h are the offset value and the correction value of the coverage ratio; wherein a larger offset value indicates a higher importance of the item involved. The hit ratio of the text indicates a ratio of the number of hits of the search keywords in the corresponding text document to the total number of search keywords. Obviously, the higher the ratio is, the closer the initial search result is to the search target. The sequence consistency indicator indicates the consistency of the sequence of the search keywords with the sequence of the search keywords appearing in the corresponding text document, and the sequence consistency is expressed by the ratio of the number of reversed sequences. For example, the number of reversed sequences of (1, 2, 3) is 0, which indicates a most sequenced arrangement, and the number of reversed sequences of (3, 2, 1) is 3, which indicates a least sequenced arrangement. The position tightness indicates a ratio of the number of hit text documents to the sum of the number of hit text documents and the number of hit spacers. For example, for the keywords “Zhang San, Zhang Si, Li Si”, the hit initial search results are “Zhang San” and “Li Si's group”, the hit keywords are “Zhang San, Li Si”, the number t of hit text documents is 2, and the number of the hit spacers is 1 (since there is a “Zhang Si” between the hit keywords). Therefore, the position tightness=2/(1+2)=⅔. The coverage ratio indicates a ratio of hit keywords to the total fields of all hit text documents.

The unit 702 for calculating the weight of update time dimension is configured to acquire a time interval between the last chat time and the current time according to the initial search results, and calculate a ratio of an attenuation constant to the sum of the time interval and the attenuation constant to obtain the weight of the chat update time.

In one of the embodiments, the formula of calculating the weight of the update time dimension is:

update_time_weight=factor/(factor+update_time_secs);

wherein update_time_weight is the weight of the update time dimension, factor is a constant which is attenuated over time, and the unit of the factor is second. Herein, the calculation is performed on a basis of attenuating by a half in 30 days, i.e., factor=30*24*3600=2592000. update_time_secs is the number of seconds till now since the last chat time. For example, if the last chat time is 30 days ago, then update_time_secs=30*24*3600=259200, and the update time dimension update_time_weight=259200/(259200+259200)=½.

The unit 703 for calculating the weight of click rate is configured to acquire the number of user clicks of the initial search results, and assign a value to the weight of the click rate according to the number of user clicks; wherein the weight of the click rate is in direct proportional to the number of user clicks.

The currently searching user's clicks of the initial search results also often reflect the quality of the initial search results. For the initial search results clicked at a high frequency, the weights thereof are increased, and they are displayed preferentially at the time of ranking. Other users' clicks of the initial search results may also reflect the quality of the initial search results, which is specifically expressed as the ClickHeat of the initial search results. The ClickHeat of the initial search results may be calculated in real time. For example, in a certain period of time, if a certain popular person (initial search result) is clicked for many times, it can be ranked ahead immediately. Currently, the number of clicks of the initial search results is recorded in a database, and each initial search result may be ranked by scanning the number of clicks of the initial search results in real time. A higher ranking indicates a larger weight of the click rate, that is, the weight of the click rate is in direct proportion to the number of user clicks.

In one of the embodiments, as shown in FIG. 8, the comprehensive weight calculation module includes a normalization unit 801 and a substitution unit 802.

The normalization unit 801 is configured to normalize the weight of the text similarity, the weight of the update time dimension, and the weight of the click rate to a decimal between 0 and 1.

The fusion calculation unit 802 is configured to perform fusion calculation according to the normalized weight of the text similarity, the normalized weight of the update time dimension and the normalized weight of the click rate to obtain the comprehensive weight of each of the initial search results.

In one of the embodiments, the comprehensive weight calculation module includes: a weight acquisition unit, configured to calculate the weight of the text similarity, the weight of the update time dimension and the weight of the click rate according to the text similarity, the update time dimension and the click rate; an offset value and correction value acquisition unit, configured to acquire an offset value and a correction value respectively, according to the weight of the text similarity, the weight of the update time dimension and the weight of the click rate; a fusion coefficient calculation unit, configured to obtain a fusion coefficient by calculating a sum of a product of the weight of the text similarity and the corresponding offset value, and the corresponding correction value, to obtain a fusion coefficient by calculating a sum of a product of the weight of the update time dimension and the corresponding offset value, and the corresponding correction value, and to obtain a fusion coefficient by calculating a sum of a product of the weight of the click rate and the corresponding offset value, and the corresponding correction value; and a comprehensive weight calculation unit, configured to multiply the fusion coefficients to obtain a comprehensive weight of each of the initial search results.

In a specific embodiment, the formula of calculating the comprehensive weight is as follows:

weight=(a1*text_weight+b1)*(a2*update_time_weight+b2)*(a3*click rate+b3);

wherein weight is the weight of the initial search result, text_weight is the weight of the text similarity, update_time_weight is the weight of the update time dimension, and click rate is the weight of the click rate. In the formula, each parentheses includes therein a calculation of the fusion coefficient, wherein text_weight represents the weight of the text similarity, a1 is the offset value, b1 is the correction value, and a first fusion coefficient is calculated by a1*text_weight+b1; update_time_weight represents the weight of the update time dimension, a2 is the offset value, b2 is the correction value, and a second fusion coefficient is calculated by a2*update_time_weight+b2; and a plurality of fusion coefficients are multiplied to obtain the comprehensive weight of the initial search result. In the formula, each of a1, a2 and a3 is an offset value, and each of b1, b2 and b3 is a correction value.

In an enterprise communication tool, by ranking the initial search results according the magnitudes of the weights thereof as in the embodiment of the present application, the ranking is no longer merely limited to a single time-based ranking. For various types of search objects such as contacts or group chats, a mixed ranking can be performed so that the most desired initial search results are presented to the users, thereby improving the efficiency of enterprise communication.

For the specific definition of the multi-dimensional search ranking apparatus, reference may be made to the above definition of the search ranking method, and details are not described herein again. The various modules in the above multi-dimensional search ranking apparatus may be implemented entirely or partially by software, hardware, and a combination thereof. Each of the above modules may be embedded in or independent from a processor of an electronic device in a form of hardware, or may be stored in a memory of an electronic device in a form of software so as to be called by the processor to perform operations corresponding to the above various modules.

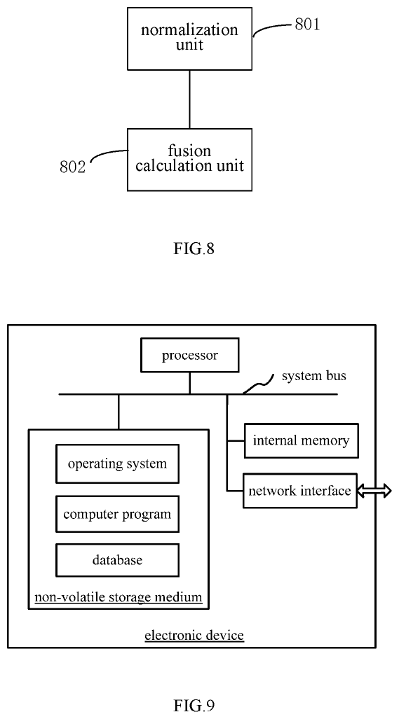

In an embodiment, an electronic device is provided, which may be a server, and an internal structure diagram thereof may be as shown in FIG. 9. The electronic device includes a processor, a memory, a network interface and a database that are connected by a system bus. The processor of the electronic device is configured to provide computing and control capabilities. The memory of the electronic device includes a non-volatile storage medium and an internal memory. The non-volatile storage medium has an operating system, a computer program and a database stored thereon. The internal memory provides an environment for operation of the operating system and the computer program on the non-volatile storage medium. The database of the electronic device is configured to store the initial search results, the number of other users' clicks of the initial search results, and the number of the currently searching users' clicks of the initial search results. The network interface of the electronic device is configured to communicate with an external terminal via a network connection. The computer program is executed by the processor to implement a multi-dimensional search ranking method.

It can be understood by those skilled in the art that the structure shown in FIG. 9 is only a block diagram of a part of the structure related to the solution of the present application, and does not constitute a limitation on the electronic device to which the solution of the present application is applied. The specific electronic device may include more or fewer components than those shown in the figures, or it may be combined with certain components, or it may have a different arrangement of components.

In an embodiment, an electronic device is provided, which includes a memory and a processor, wherein the memory has a computer program stored therein, and when the computer program is executed by the processor, the following steps are implemented:

acquiring search keywords and determining a plurality of initial search results that match with the keywords;

extracting a text similarity, an update time dimension and a click rate associated with each of the initial search results;

acquiring a weight of the text similarity, a weight of the update time dimension and a weight of the click rate according to the text similarity, the update time dimension and the click rate, and performing a fusion calculation according to the weight of the text similarity, the weight of the update time dimension and the weight of the click rate to obtain a comprehensive weight of each of the initial search results; and

ranking the plurality of initial search results according to the comprehensive weights.

In an embodiment, a computer readable storage medium is provided, which has a computer program stored thereon, wherein when the computer program is executed by a processor, the following steps are implemented:

acquiring search keywords and determining a plurality of initial search results that match with the keywords;

extracting a text similarity, an update time dimension and a click rate associated with each of the initial search results;

acquiring a weight of the text similarity, a weight of the update time dimension and a weight of the click rate according to the text similarity, the update time dimension and the click rate, and performing a fusion calculation according to the weight of the text similarity, the weight of the update time dimension and the weight of the click rate to obtain a comprehensive weight of each of the initial search results; and

ranking the plurality of initial search results according to the comprehensive weights.

It can be understood by those skilled in the art that all or part of the flow charts of implementing the methods of the above embodiments may be completed by a computer program instructing relevant hardware, and the computer program may be stored in a non-volatile computer readable storage medium. When executed, the computer program may include the flow charts of the embodiments of the methods described above. Any reference to a memory, storage, database or other medium used in the various embodiments provided by the present application may include non-volatile memory and/or volatile memory. The non-volatile memory may include read-only memory (ROM), programmable ROM (PROM), electrically programmable ROM (EPROM), electrically erasable programmable ROM (EEPROM), or flash memory. The volatile memory may include random access memory (RAM) or external cache memory. By way of illustration without limitation, RAM is available in a variety of forms, such as static RAM (SRAM), dynamic RAM (DRAM), synchronous DRAM (SDRAM), double data rate SDRAM (DDRSDRAM), enhanced SDRAM (ESDRAIVI), Synchlink DRAM (SLDRAIVI), Memory Bus (Rambus) Direct RAM (RDRAM), Direct Memory Bus Dynamic RAM (DRDRAIVI), and Memory Bus Dynamic RAM (RDRAM), etc.

The technical features of the above embodiments may be arbitrarily combined. For the sake of brevity of description, not all possible combinations of the technical features in the above embodiments are described. However, as long as there is no contradiction in the combination of these technical features, it should be considered as falling within the scope described in this specification.

The above described embodiments are merely illustrative of several implementations of the present application, and the description thereof is more specific and detailed, but it is not to be construed as limiting the scope of the present application. It should be noted that several variations and modifications may also be made by those skilled in the art without departing from the spirit and scope of the present application, and all these variations and modifications will fall within the scope of protection of the present application. Therefore, the scope of protection of the present application should be determined by the appended claims.

1. A search ranking method, comprising:
acquiring search keywords and determining a plurality of initial search results that match with the keywords;
extracting a text similarity, an update time dimension and a click rate associated with each of the initial search results;
acquiring a weight of the text similarity, a weight of the update time dimension and a weight of the click rate according to the text similarity, the update time dimension and the click rate, and performing a fusion calculation according to the weight of the text similarity, the weight of the update time dimension and the weight of the click rate to obtain a comprehensive weight of each of the initial search results; and
ranking the plurality of initial search results according to the comprehensive weights.

2. The method according to claim 1, wherein the acquiring the weight of the text similarity comprises:
calculating a hit ratio, a sequence consistency indicator, a position tightness, and a coverage ratio of the keywords in the initial search results; and
calculating the weight of the text similarity according to the hit ratio, the sequence consistency indicator, the position tightness, and the coverage ratio.

3. The method according to claim 2, wherein the step of calculating the weight of the text similarity according to the hit ratio, the sequence consistency indicator, the position tightness and the coverage ratio comprises:
acquiring an offset value and a correction value respectively, according to the hit ratio, the sequence consistency indicator, the position tightness, and the coverage ratio; and
performing a fusion calculation according to the hit ratio, the sequence consistency indicator, the position tightness, the coverage ratio, the offset value and the correction value to obtain the weight of the text similarity.

4. The method according to claim 1, wherein the acquiring the weight of the update time dimension comprises:
acquiring a time interval between the last chat time and the current time according to the initial search results; and
calculating a ratio of an attenuation constant to the sum of the time interval and the attenuation constant to obtain the weight of the chat update time.

5. The method according to claim 1, wherein the acquiring the weight of the click rate comprises:
acquiring the number of user clicks of the initial search results; and
assigning a value to the weight of the click rate according to the number of user clicks;
wherein the weight of the click rate is in direct proportional to the number of user clicks.

6. The method according to claim 1, wherein the performing the fusion calculation according to the weight of the text similarity, the weight of the update time dimension and the weight of the click rate to obtain the comprehensive weight of each of the initial search results comprises:
normalizing the weight of the text similarity, the weight of the update time dimension, and the weight of the click rate to a decimal between 0 and 1; and
performing the fusion calculation according to the normalized weight of the text similarity, the normalized weight of the update time dimension and the normalized weight of the click rate to obtain the comprehensive weight of each of the initial search results.

7. The method according to claim 1, wherein the acquiring the weight of the text similarity, the weight of the update time dimension and the weight of the click rate according to the text similarity, the update time dimension and the click rate, and performing the fusion calculation according to the weight of the text similarity, the weight of the update time dimension and the weight of the click rate to obtain the comprehensive weight of each of the initial search results comprises:
calculating the weight of the text similarity, the weight of the update time dimension and the weight of the click rate according to the text similarity, the update time dimension and the click rate;
acquiring an offset value and a correction value respectively, according to the weight of the text similarity, the weight of the update time dimension and the weight of the click rate;
obtaining a fusion coefficient by calculating a sum of a product of the weight of the text similarity and the corresponding offset value, and the corresponding correction value; obtaining a fusion coefficient by calculating a sum of a product of the weight of the update time dimension and the corresponding offset value, and the corresponding correction value; and obtaining a fusion coefficient by calculating a sum of a product of the weight of the click rate and the corresponding offset value, and the corresponding correction value; and
multiplying the fusion coefficients to obtain a comprehensive weight of each of the initial search results.

8. The method according to claim 1, wherein before extracting the text similarity, the update time dimension, and the click rate associated with each of the initial search results, the method further comprises:
screening the initial search results;
wherein the screening the initial search results comprises:
not ranking the initial search results of the users who have resigned and have no chat records; and
ranking the initial search results of unregistered users at the end.

9. A search ranking apparatus, comprising:
at least one processor; and
at least one memory communicatively coupled to the at least one processor and storing instructions that upon execution by the at least one processor cause the apparatus to:
acquire search keywords and determine a plurality of initial search results that match with the keywords;
extract a text similarity, an update time dimension and a click rate associated with each of the initial search results;
acquire a weight of the text similarity, a weight of the update time dimension and a weight of the click rate according to the text similarity, the update time dimension and the click rate, and perform a fusion calculation according to the weight of the text similarity, the weight of the update time dimension and the weight of the click rate to obtain a comprehensive weight of each of the initial search results; and
rank the plurality of initial search results according to the comprehensive weights.

10. (canceled)

11. A computer readable storage medium having a computer program stored thereon, wherein when the computer program is executed by a processor, causing the processor to perform operations, the operations comprising:
acquiring search keywords and determining a plurality of initial search results that match with the keywords;
extracting a text similarity, an update time dimension and a click rate associated with each of the initial search results;
acquiring a weight of the text similarity, a weight of the update time dimension and a weight of the click rate according to the text similarity, the update time dimension and the click rate, and performing a fusion calculation according to the weight of the text similarity, the weight of the update time dimension and the weight of the click rate to obtain a comprehensive weight of each of the initial search results; and
ranking the plurality of initial search results according to the comprehensive weights.

12. The apparatus according to claim 9, wherein the processor is configured to execute the computer readable instructions to further perform operations of:
calculating a hit ratio, a sequence consistency indicator, a position tightness, and a coverage ratio of the keywords in the initial search results; and
calculating the weight of the text similarity according to the hit ratio, the sequence consistency indicator, the position tightness, and the coverage ratio.

13. The apparatus according to claim 12, wherein the processor is configured to execute the computer readable instructions to further perform operations of:
acquiring an offset value and a correction value respectively, according to the hit ratio, the sequence consistency indicator, the position tightness, and the coverage ratio; and
performing a fusion calculation according to the hit ratio, the sequence consistency indicator, the position tightness, the coverage ratio, the offset value and the correction value to obtain the weight of the text similarity.

14. The apparatus according to claim 9, wherein the processor is configured to execute the computer readable instructions to further perform operations of:
acquiring a time interval between the last chat time and the current time according to the initial search results; and
calculating a ratio of an attenuation constant to the sum of the time interval and the attenuation constant to obtain the weight of the chat update time.

15. The apparatus according to claim 9, wherein the processor is configured to execute the computer readable instructions to further perform operations of:
acquiring the number of user clicks of the initial search results; and
assigning a value to the weight of the click rate according to the number of user clicks;
wherein the weight of the click rate is in direct proportional to the number of user clicks.

16. The apparatus according to claim 9, wherein the processor is configured to execute the computer readable instructions to further perform operations of:
normalizing the weight of the text similarity, the weight of the update time dimension, and the weight of the click rate to a decimal between 0 and 1; and
performing the fusion calculation according to the normalized weight of the text similarity, the normalized weight of the update time dimension and the normalized weight of the click rate to obtain the comprehensive weight of each of the initial search results.

17. The apparatus according to claim 9, wherein the processor is configured to execute the computer readable instructions to further perform operations of:
calculating the weight of the text similarity, the weight of the update time dimension and the weight of the click rate according to the text similarity, the update time dimension and the click rate;
acquiring an offset value and a correction value respectively, according to the weight of the text similarity, the weight of the update time dimension and the weight of the click rate;
obtaining a fusion coefficient by calculating a sum of a product of the weight of the text similarity and the corresponding offset value, and the corresponding correction value; obtaining a fusion coefficient by calculating a sum of a product of the weight of the update time dimension and the corresponding offset value, and the corresponding correction value; and obtaining a fusion coefficient by calculating a sum of a product of the weight of the click rate and the corresponding offset value, and the corresponding correction value; and
multiplying the fusion coefficients to obtain a comprehensive weight of each of the initial search results.

18. The apparatus according to claim 9, wherein the processor is configured to execute the computer readable instructions to further perform operations of:
screening the initial search results;
wherein the screening the initial search results comprises:
not ranking the initial search results of the users who have resigned and have no chat records; and
ranking the initial search results of unregistered users at the end.
